(19) United States
(12) Patent Application Publication
(10) Pub. No.: US 2020/0232395 A1
(43) Pub. Date: Jul. 23, 2020

(54) METHOD AND SYSTEM FOR OPERATING A GAS TURBINE ENGINE COUPLED TO AN AIRCRAFT PROPELLER

(71) Applicant: PRATT & WHITNEY CANADA CORP., Longueuil (CA)

(72) Inventors: Jasraj CHAHAL, Lasalle (CA); Carmine LISIO, Laval (CA); Darragh MCGRATH, Montreal (CA); Giancarlo ZINGARO, Pointe-Claire (CA)

(21) Appl. No.: 16/250,256

(22) Filed: Jan. 17, 2019

(51) Int. Cl. F02C 9/58; B64D 31/06; B64D 27/10

(52) U.S. Cl. CPC F02C 9/58; B64D 31/06; F05D 2270/051; F05D 2270/54; F05D 2270/053; B64D 27/10

(57) ABSTRACT

Methods and systems for operating a gas turbine engine coupled to an aircraft propeller are described herein. A request for reverse of the propeller thrust is received from a power lever of the aircraft. A blade angle of the propeller is determined. Reverse thrust of the propeller is inhibited when the blade angle exceeds a threshold. Reverse thrust of the propeller based on the request is enabled when the blade angle is below the threshold.

### TECHNICAL FIELD

The present disclosure relates generally to gas turbine engines, and more particularly to controlling engine operation.

### BACKGROUND OF THE ART

For propeller driven aircraft, a control system may adjust the blade angle of the propeller blades to cause a transition from forward to reverse thrust during landing. The transition from forward to reverse thrust requires that the propeller blades transition through a zone of operation known as “disking” or blade angle of minimum rotational drag, where the engine typically operates at low power. A pilot uses feedback of the position of the propeller blade angle to determine when to apply an increase in engine power at landing. However, if an increase in engine power is applied too soon when transitioning from forward to reverse thrust during landing, positive thrust may occur rather than reverse thrust.

As such, there is a need for improvement.

### SUMMARY

In one aspect, there is provided a method for operating a gas turbine engine coupled to an aircraft propeller. The method comprises receiving a request for reverse thrust of the propeller from a power lever of the aircraft, obtaining a blade angle of the propeller, inhibiting reverse thrust of the propeller when the blade angle exceeds a threshold, and enabling reverse thrust of the propeller based on the request when the blade angle is below the threshold.

In another aspect, there is provided a system for operating a gas turbine engine coupled to an aircraft propeller. The system comprises a processing unit and a non-transitory computer-readable memory having stored thereon program instructions. The program instructions are executable by the processing unit for receiving a request for reverse thrust of the propeller from a power lever of the aircraft, obtaining a blade angle of the propeller, inhibiting reverse thrust of the propeller when the blade angle exceeds a threshold, and enabling reverse thrust of the propeller based on the request when the blade angle is below the threshold.

### BRIEF DESCRIPTION OF THE DRAWINGS

Reference is now made to the accompanying figures in which:

FIG. 1 is a schematic of an example gas turbine engine and propeller, in accordance with an illustrative embodiment;

FIG. 2A is a schematic diagram illustrating a system for controlling operation of the engine and propeller of FIG. 1, in accordance with an illustrative embodiment;

FIG. 2B is a schematic diagram illustrating the system of FIG. 2A with a propeller controller and engine controller, in accordance with an illustrative embodiment;

FIG. 2C is a schematic diagram illustrating the system of FIG. 2C with dual channels, in accordance with an illustrative embodiment;

FIG. 3A is a flowchart of a method for controlling operation of an engine, in accordance with an illustrative embodiment;

FIG. 3B is a flowchart illustrating another embodiment of the method for controlling operation of an engine, in accordance with an illustrative embodiment;

FIG. 4 is a block diagram of an example computing device for controlling operation of an engine and/or propeller, in accordance with an illustrative embodiment.

It will be noted that throughout the appended drawings, like features are identified by like reference numerals.

### DETAILED DESCRIPTION

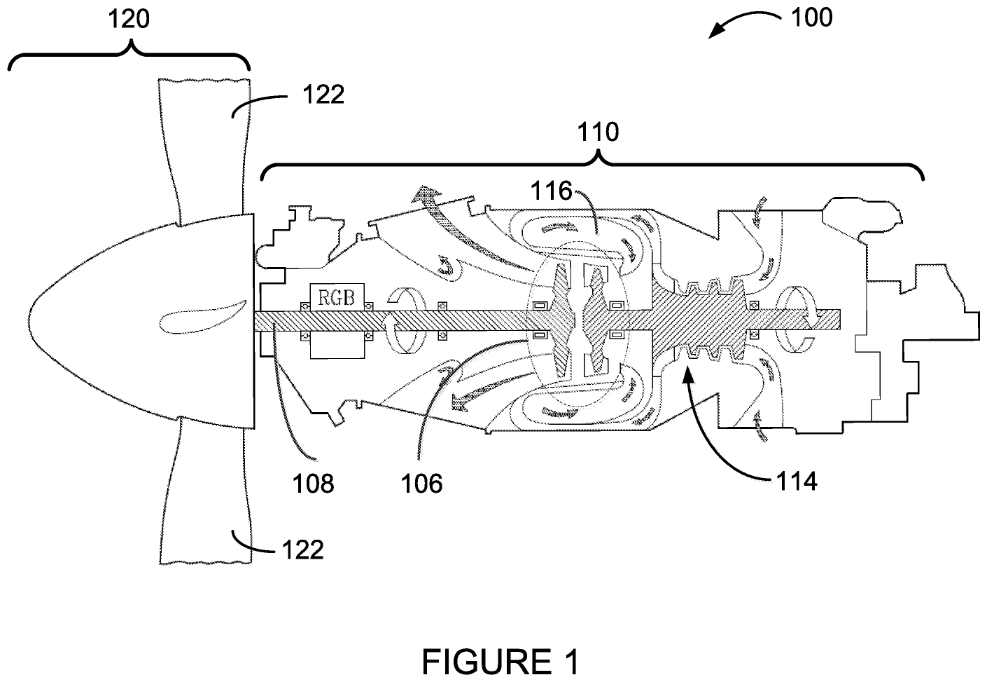

FIG. 1 illustrates an aircraft powerplant 100 for an aircraft of a type preferably provided for use in subsonic flight, generally comprising an engine 110 and a propeller 120. The powerplant 100 generally comprises in serial flow communication the propeller 120 attached to a shaft 108 and through which ambient air is propelled, a compressor section 114 for pressurizing the air, a combustor 116 in which the compressed air is mixed with fuel and ignited for generating an annular stream of hot combustion gases, and a turbine section 106 for extracting energy from the combustion gases. The propeller 120 converts rotary motion from the shaft 108 of the engine 110 to provide propulsive force for the aircraft, also known as thrust. The propeller 120 comprises two or more propeller blades 122. A blade angle of the propeller blades 122 may be adjusted. The blade angle may be referred to as a beta angle, an angle of attack or a blade pitch. The powerplant 100 may be implemented to comprise a single or multi-spool gas turbine engine, where the turbine section 106 is connected to the propeller 120 through a reduction gearbox (RGB).

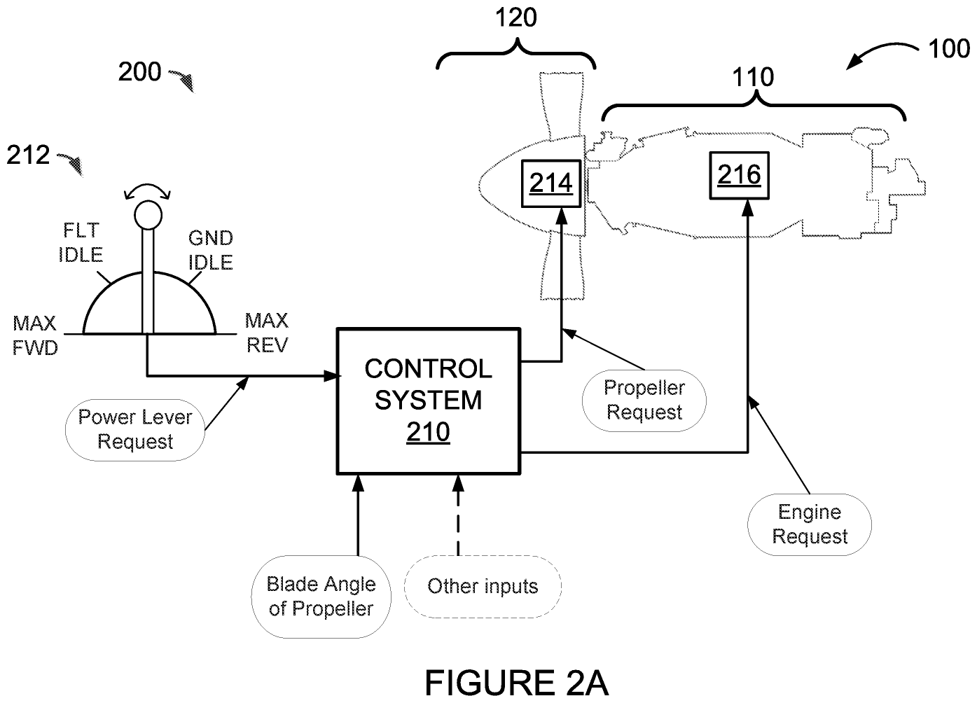

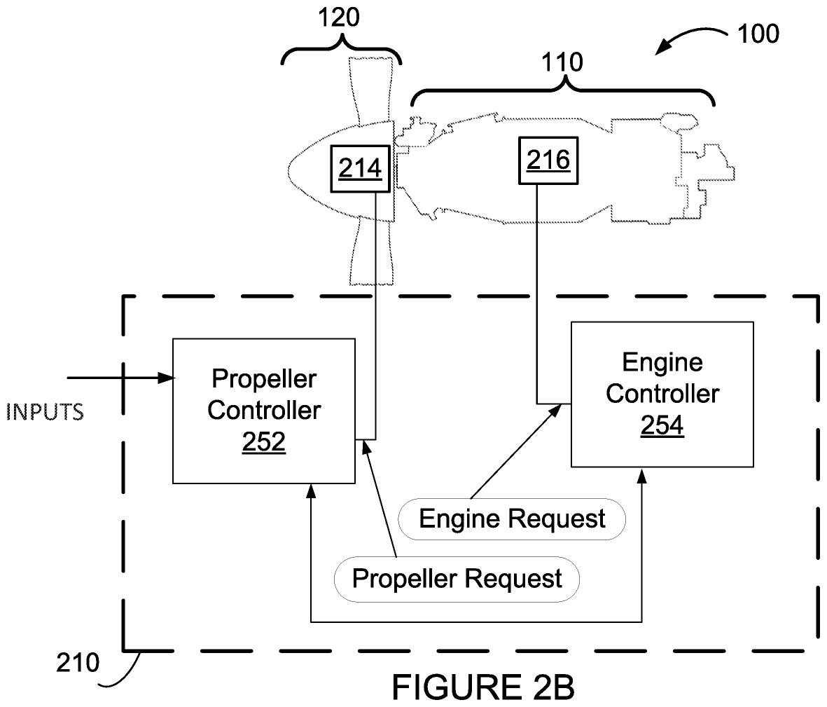

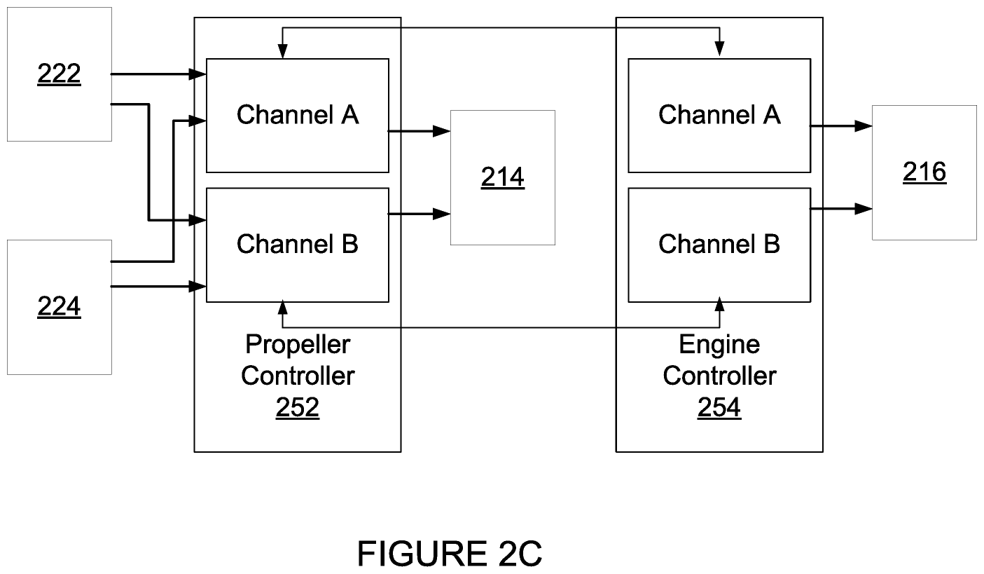

With reference to FIG. 2A, there is illustrated a system 200 for operating the powerplant 100 in accordance with an embodiment. In this embodiment, a control system 210 receives a power lever request from a power lever 212 of the aircraft under control by a pilot of the aircraft. The power lever request is indicative of the type of thrust demanded by the power lever 212. The power lever request is indicative of a position of the power lever 212. Several power lever positions can be selected, including those for (1) maximum forward thrust (MAX FWD), which is typically used during takeoff; (2) flight idle (FLT IDLE), which may be used in flight during approach or during taxiing on the ground; (3) ground idle (GND IDLE), at which the propeller 120 is spinning, but providing very low thrust; (4) maximum reverse thrust (MAX REV), which is typically used at landing in order to slow the aircraft. Intermediate position between the abovementioned positions can also be selected.

The control system 210 receives additional inputs pertaining to the operation of the propeller 120, engine 110 and/or the aircraft. In the illustrated embodiment, the control system 210 receives a blade angle of the propeller 120. In some embodiments, the control system 210 receives an aircraft status indicative of whether the aircraft is on-ground or in-flight. The additional inputs may vary depending on practical implementations.

In general, the control system 210 is configured to control the engine 110 and the propeller 120 based on the received inputs. The control system 210 controls the engine 110 by outputting an engine request to an engine actuator 216 for adjusting engine fuel flow and controls the propeller 120 by outputting a propeller request to a propeller actuator 214 for adjusting the blade angle of the propeller 120. The engine actuator 216 and/or propeller actuator 214 may each be implemented as a torque motor, a stepper motor or any other suitable actuator. The control system 210 determines the engine request and the propeller request based on the received inputs. The propeller actuator 214 may control hydraulic oil pressure to adjust the blade angle based on the propeller request. The engine actuator 216 can adjust the fuel flow to the engine 110 based on the engine request. While the control system 210 is illustrated as separate from the powerplant 100, this is for illustrative purposes.

The control system 210 receives a request for reverse thrust of the propeller 120 from the power lever 212 of the aircraft. The control system 210 is configured to control the engine 110 to inhibit reverse thrust of the propeller 120 by preventing an increase of engine output power when the blade angle of the propeller 120 exceeds a reverse thrust blade angle threshold. The control system 210 is configured to enable reverse thrust of the propeller 120 based on the power lever request by allowing an increase of engine output power when the blade angle is below the reverse thrust blade angle threshold. Inhibiting reverse thrust refers to preventing the engine 110 from providing an output power based on the output power demanded by the power lever 212. In some embodiments, inhibiting reverse thrust comprises setting the output power of the engine 110 at a minimum level for the engine 110. Enabling reverse thrust refers to allowing the engine 110 to provide output power based on the output power demanded by the power lever 212. By enabling and inhibiting reverse thrust based on the position of the blade angle, if an increase in engine power is applied too soon when transitioning from forward to reverse thrust, this can prevent the propeller 120 from inadvertently providing positive thrust. The corresponding blade angle for the reverse thrust blade angle threshold may vary depending on practical implementations.

With reference to FIG. 2B, the control system 210 is illustrated in accordance with an embodiment. In this embodiment, a propeller controller 252 controls the propeller 120 and an engine controller 254 controls the engine 110. The propeller controller 252 determines and outputs the propeller request and the engine controller 254 determines and outputs the engine request. In this embodiment, the propeller controller 252 receives the inputs (e.g., the power lever request, blade angle, aircraft status and/or any other suitable inputs) and is in electronic communication with the engine controller for providing one or more of the received inputs to the engine controller 254. In some embodiments, the engine controller 254 additionally or alternatively receives the inputs (e.g., the power lever request, blade angle, aircraft status and/or any other suitable inputs). In some embodiments, the engine controller 254 provides one or more of the received inputs to the propeller controller 252. In some embodiments, the propeller controller 252 may determine the blade angle of the propeller 120 and provide the blade angle to the engine controller 254. In alternative embodiments, the functionality of the propeller controller 252 and the engine controller 254 may be implemented in a single controller.

To further illustrate the enabling and the inhibiting of reverse thrust, an example of a transition from forward to reverse thrust will now be described. When forward thrust is requested by the power lever 212, the control system 210 controls the blade angle of the propeller 120 and the output power of the engine 110 based on the power lever request. For instance, when the aircraft is in-flight and the power lever position is set at or above the flight idle position, the propeller controller 252 controls the blade angle above the forward thrust blade angle threshold to maintain a constant propeller speed at a propeller speed target and the engine controller 254 controls the engine output power based on the power lever position. When the propeller speed is above the target, the propeller blade angle is increased, which results in the propeller 120 displacing more air and thus reducing propeller speed. Men the propeller speed is below the target, the propeller blade angle is decreased, which results in the propeller 120 displacing less air and thus increasing propeller speed. Controlling the propeller 120 to maintain a constant speed at a propeller speed target may be referred to as speed governing. The engine output power may be determined from a schedule based on the power level position. Controlling the engine output power based on the power lever position may be referred to as power governing.

When the power lever position is moved below the ground idle position to request reverse thrust, the propeller controller 252 determines a blade angle for the propeller 120 from a blade angle schedule based on the power lever request (e.g., the power lever position) and the engine controller 254 sets the engine output power at a low power state (e.g., a minimum power level for the engine 110). The propeller controller 252 controls the blade angle to obtain a reverse blade angle which is directly related to the power lever position. Controlling the propeller blade angle based on the power lever position may be referred to as beta governing. While the blade angle is above the reverse thrust blade angle threshold, the engine controller 254 inhibits the engine 110 from increasing the power transmitted to the propeller 120 via the shaft 108 in order to prevent the propeller 120 from inadvertently providing positive thrust. Once the blade angle is below the reverse thrust blade angle threshold, the engine controller 254 can increase the power transmitted to the propeller 120 thus increasing the rotational speed, and thereby increasing thrust in the reverse direction.

The engine controller 254 may further use the aircraft status to enable or inhibit thrust. In some embodiments, the engine controller 254 enables the reverse thrust when the blade angle of the propeller 120 is below the reverse thrust blade angle threshold and the aircraft status indicates that the aircraft is on-ground. In some embodiments, the engine controller 254 inhibits reverse thrust when the blade angle is above the reverse thrust blade angle threshold or when the aircraft status indicates that the aircraft is in-flight.

With reference to FIG. 20, in some embodiments, each of the propeller controller 252 and the engine controller 254 comprise two channels A and B. For each of the controllers 252, 254, the channels A, B are redundant channels and one of the channels (e.g., channel A) is selected as being active, while the other channel remains in standby (e.g., channel B), When a channel is active, that channel is configured to generate and output the engine request or the propeller request, and when a channel is in standby, that channel does not generate and output the engine request or propeller request. When a channel is in standby, the channel is functional and able to take over control when needed. If it is determined that the presently active channel or one of the actuators 214, 216 is faulty or inoperative, the presently active channel may be inactivated and the in standby channels is activated. Similarly, if, during operation, an input to a presently active channel is erroneous or inexistent, the presently active channel may be inactivated and one of the in standby channels is activated.

In the illustrated embodiment, each channel A, B of the propeller controller 252 receives the power lever request from at least one sensor 224 (e.g., a dual coil rotary variable differential transformer, where one coil provides the power lever request to channel A and the other coil provides the power lever request to channel B). Each channel A, B of the propeller controller 252 also receives the blade angle of the propeller from at least one sensor 224 (e.g., a dual coil rotary variable differential transformer, where one coil provides the blade angle to channel A and the other coil provides the blade angle to channel B). The propeller actuator 214 (e.g., a dual input pitch change mechanism actuator) modulates the blade angle based on the propeller request from the active channel of the propeller controller 252. In this example, the engine controller 254 receives the blade angle and the power lever request from propeller controller 254. The engine actuator 216 (e.g., a dual input toque motor) modulates fuel flow to engine 110 based on the engine request from the active channel of the engine controller 254.

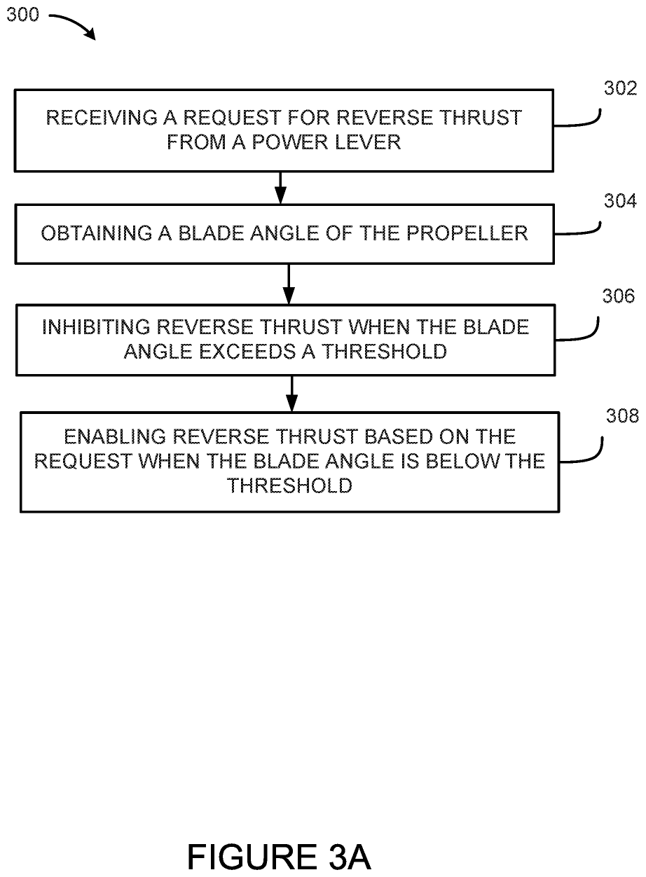

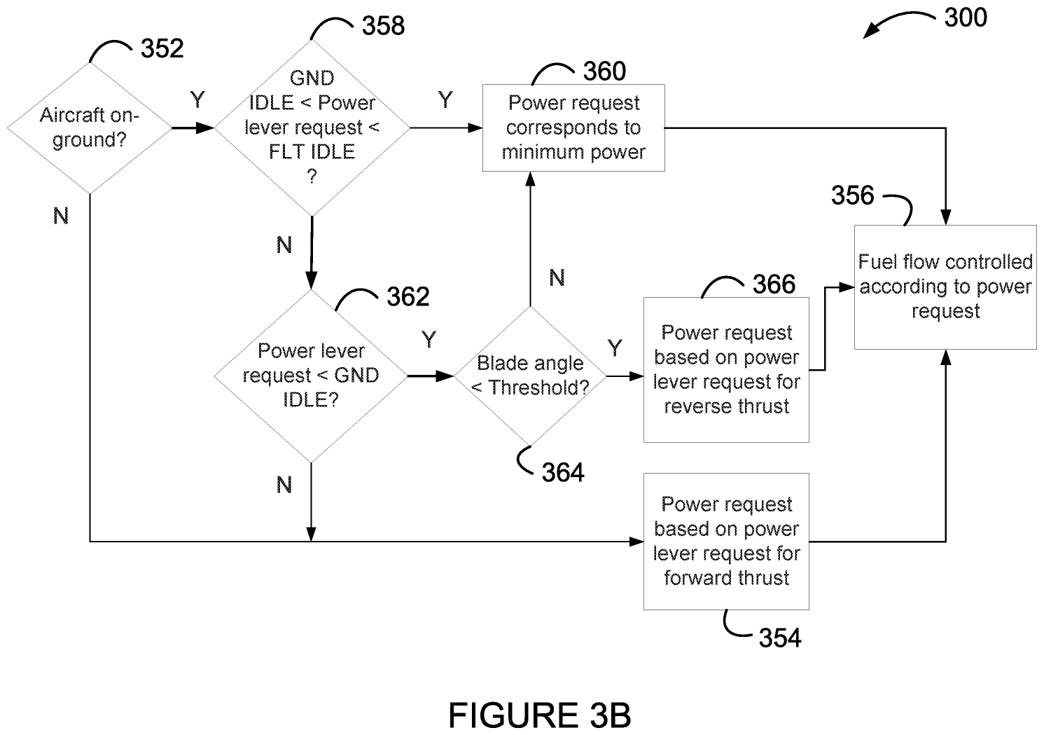

With reference to FIG. 3A, there is illustrated a flowchart of a method 300 for operating an engine, such as the engine 110. The method 300 may be performed by the control system 210 and/or the engine controller 254. At step 302, a request for reverse thrust of the propeller 120 is received from the power lever 212 of the aircraft. Receiving the request for reverse thrust may comprise receiving a position of the power lever 212 from at least one sensor associated with the power lever 212. Receiving the request for reverse thrust may comprise receiving the request for reverse thrust from the propeller controller 252. At step 304, a blade angle of the propeller 120 is obtained. Obtaining the blade angle of the propeller 120 may comprise receiving the blade angle of the propeller 120 from the propeller controller 252. At step 306, reverse thrust of the propeller 120 is inhibited when the blade angle exceeds the reverse thrust blade angle threshold. At step 308, reverse thrust of the propeller 120 is enabled when the blade angle is below the reverse thrust blade angle threshold. The reverse thrust blade angle threshold may correspond to a minimum blade angle at which the propeller can provide reverse thrust. In some embodiments, enabling the reverse thrust comprises determining a power demand for the engine 110 based on the power lever request (e.g., based on the position of the power lever 212) and controlling the output power of the engine 110 based on the power demand. Controlling the output power of the engine 110 may comprise determining a fuel flow for the engine 110 based on the power demand and outputting a fuel flow request to the engine actuator 216 for controlling the fuel flow to the engine 110.

With additional reference to FIG. 3B there is illustrated another embodiment of the method 300 for operating an engine, such as the engine 110. In some embodiments, the method 300 comprises receiving the power lever request from the power lever 212 and obtaining the aircraft status indicative of whether the aircraft is on-ground or in-flight is obtained. In some embodiments, the method 300 inhibits reverse thrust when the aircraft status indicates that the aircraft is in-flight and/or when the blade angle exceeds the reverse thrust blade angle threshold, and enables reverse thrust based on the request for reverse thrust when the aircraft status indicates that the aircraft is on-ground and when the blade angle is below the threshold.

Each of the request for reverse thrust, the blade angle of the propeller and/or the aircraft status may be received from a respective measuring device comprising one or more sensors. In some embodiments, the request for reverse thrust, the blade angle of the propeller and/or the aircraft status are obtained via existing components as part of engine control and/or operation. For example, the request for reverse thrust, the blade angle of the propeller and/or the aircraft status may be provided from one of an engine controller, a propeller controller or an aircraft computer. The request for reverse thrust, the blade angle of the propeller and/or the aircraft status may be dynamically obtained in real time, may be obtained regularly in accordance with any predetermined time interval, or may be obtained irregularly.

At step 352, the method 300 comprises determining if the aircraft is on-ground or in-flight based on the aircraft status. If the aircraft is in-flight, at step 354, a power request for the engine 110 is determined based on the power lever request, which is for forward thrust. The fuel flow to the engine 110 is controlled according to the power request at step 356. At step 352, if it is determined that the aircraft is on-ground, then the method 300 proceeds to step 358.

At step 358, the method 300 comprises determining if the power lever request indicates that the position of the power lever 212 is between the ground idle and the flight idle position. If the position of the power lever 212 is between the ground idle and the flight idle position, at step 360, the power request for the engine 110 is determined to correspond to the minimum power for the engine 110. At step 358, if the position of the power lever 212 is not between the ground idle and the flight idle position, the method 300 proceeds to step 362.

At step 362, the method 300 comprises determining if the power lever request indicates that the position of the power lever 212 is below the ground idle position. If the power lever is not below the ground idle position, at step 354, a power request for the engine 110 is determined based on the power lever request (e.g., power lever position), which is for forward thrust. At step 362, if the power lever is below the ground idle position, the method 300 proceeds to step 364.

At step 364, the method 300 comprises determining if the blade angle is below the reverse thrust blade angle threshold. If the blade angle is not below the reverse thrust blade angle threshold, at step 360, the power request for the engine 110 is determined to correspond to the minimum power for the engine 110. If the blade angle is below the reverse thrust blade angle threshold, at step 366, the power request for the engine 110 is determined based on the power lever request (e.g., power lever position), which is for reverse thrust.

In some embodiments, the systems and methods described herein may be used with aircraft comprising two powerplants. For example, each powerplant may be implemented according to the powerplant 100. Accordingly, the systems and method described herein may be used for operating a first engine coupled to a first propeller and for operating a second engine coupled to a second propeller. In some embodiments, step 304 of FIG. 3A, comprises obtaining a first blade angle of the first propeller and a second blade angle of the second propeller. In some embodiments, at step 306 of FIG. 3A, reverse thrust is inhibited when at least one of the first blade angle and the second blade angle exceeds the reverse thrust blade angle threshold. In some embodiments, reverse thrust is inhibited when the aircraft status indicates that the aircraft is in-flight and/or when at least one of the first blade angle and the second blade angle exceeds the reverse thrust blade angle threshold. In some embodiments, at step 308 of FIG. 3A, reverse thrust is enabled when the first blade angle and the second blade angle are below the reverse thrust blade angle threshold. In some embodiments, reverse thrust is enabled when the aircraft status indicates that the aircraft is on-ground and when the first blade angle and the second blade angle are below the reverse thrust blade angle threshold. A first engine controller associated with the first engine may perform the method 300 for enabling and inhibiting reverse thrust of the first engine and a second engine controller associated with the second engine may perform the method 300 for enabling and inhibiting reverse thrust of the second engine. Alternatively, in some embodiments, each powerplant of a multipowerplant aircraft may independently implement the method 300 and/or comprises the control system 210.

In some embodiments, the systems and/or methods described herein may be used with the systems and/or method described in U.S. patent application Ser. No. 16/159,970, the contents of which is hereby incorporated by reference.

The systems and methods described herein may be used for inhibiting and enabling forward thrust. In some embodiments, the control system 210 receives a request for forward thrust from the power lever 212. The control system 210 may be configured to control the engine 110 to inhibit forward thrust when the blade angle of the propeller 120 is below a forward thrust blade angle threshold. The control system 210 may be configured to enable forward thrust based on the power lever request when the blade angle exceeds the forward thrust blade angle threshold. The corresponding blade angle for the forward thrust blade angle threshold may vary depending on practical implementations.

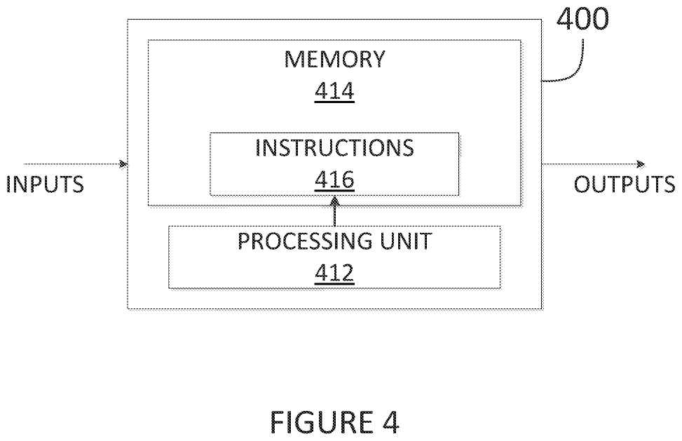

With reference to FIG. 4, an example of a computing device 400 is illustrated. The control system 210 may be implemented with one or more computing devices 400. For example, each of the propeller controller 252 and the engine controller 254 may be implemented by a separate computing device 400. The computing device 400 comprises a processing unit 412 and a memory 414 which has stored therein computer-executable instructions 416. The processing unit 412 may comprise any suitable devices configured to implement the method 300 such that instructions 416, when executed by the computing device 400 or other programmable apparatus, may cause the functions/acts/steps performed as part of the method 300 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412. Note that the computing device 400 can be implemented as part of a full-authority digital engine controls (FADEC) or other similar device, including electronic engine control (EEC), engine control unit (EJC), electronic propeller control, propeller control unit, and the like.

The methods and systems for operating an engine described herein may be implemented in a high level procedural or object oriented programming or scripting language, or a combination thereof, to communicate with or assist in the operation of a computer system, for example the computing device 400. Alternatively, the methods and systems for operating an engine may be implemented in assembly or machine language. The language may be a compiled or interpreted language. Program code for implementing the methods and systems for operating an engine may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for operating an engine may also be considered to be implemented by way of a non-transitory computer-readable storage medium having a computer program stored thereon. The computer program may comprise computer-readable instructions which cause a computer, or more specifically the processing unit 412 of the computing device 400, to operate in a specific and predefined manner to perform the functions described herein, for example those described in the method 300.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for operating an engine may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for operating a gas turbine engine coupled to an aircraft propeller, the method comprising:
receiving a request for reverse thrust of the propeller from a power ever of the aircraft;
obtaining a blade angle of the propeller;
inhibiting reverse thrust of the propeller when the blade angle exceeds a threshold; and
enabling reverse thrust of the propeller based on the request when the blade angle is below the threshold.

2. The method of claim 1, further comprising obtaining an aircraft status indicative of whether the aircraft is on-ground or in-flight, enabling the reverse thrust when the aircraft status indicates that the aircraft is on-ground, and inhibiting the reverse thrust when the aircraft status indicates that the aircraft is in-flight.

3. The method of claim 1, wherein inhibiting the reverse thrust comprises setting an output power of the engine at a minimum level for the engine.

4. The method of claim 1, wherein the threshold corresponds to a minimum blade angle at which the propeller can provide reverse thrust.

5. The method of claim 1, wherein receiving the request for reverse thrust comprises receiving a position of the power lever from at least one sensor.

6. The method of claim 5, wherein the position of the power lever is below a ground idle position.

7. The method of claim 5, wherein enabling the reverse thrust comprises determining a power demand for the engine based on the position of the power lever and controlling an output power of the engine based on the power demand.

8. The method of claim 7, wherein controlling the output power of the engine comprises determining a fuel flow for the engine based on the power demand and outputting the fuel flow request to a torque motor for controlling a fuel flow to the engine.

9. The method of claim 1, wherein obtaining the blade angle of the propeller comprises obtaining the blade angle from a propeller controller.

10. The method of claim 1, wherein the aircraft propeller is a first aircraft propeller and the blade angle is a first blade angle, the method further comprising obtaining a second blade angle of a second aircraft propeller, and wherein enabling reverse thrust comprises enabling reverse thrust when the first blade angle and second blade angle are below the threshold and inhibiting reverse thrust comprises inhibiting reverse thrust when at least one of the first blade angle and the second blade angle exceeds the threshold.

11. A system for operating a gas turbine engine coupled to an aircraft propeller, the system comprising:
a processing unit; and
a non-transitory computer-readable memory having stored thereon program instructions executable by the processing unit for:
receiving a request for reverse thrust of the propeller from a power lever of the aircraft;
obtaining a blade angle of the propeller;
inhibiting reverse thrust of the propeller when the blade angle exceeds a threshold; and
enabling reverse thrust of the propeller based on the request when the blade angle is below the threshold.

12. The system of claim 11, wherein the program instructions are further executable by the processing unit for obtaining an aircraft status indicative of whether the aircraft is on-ground or in-flight, enabling the reverse thrust when the aircraft status indicates that the aircraft is on-ground, and inhibiting the reverse thrust when the aircraft status indicates that the aircraft is in-flight.

13. The system of claim 11, wherein inhibiting the reverse thrust comprises setting an output power of the engine at a minimum level for the engine.

14. The system of claim 11, wherein the threshold corresponds to a minimum blade angle at which the propeller can provide reverse thrust.

15. The system of claim 11, wherein receiving the request for reverse thrust comprises receiving a position of the power lever from at least one sensor.

16. The system of claim 15, wherein the position of the power lever is below a ground idle position.

17. The system of claim 15, wherein enabling the reverse thrust comprises determining a power demand for the engine based on the position of the power lever and controlling an output power of the engine based on the power demand.

18. The system of claim 17, wherein controlling the output power of the engine comprises determining a fuel flow for the engine based on the power demand and outputting the fuel flow request to a torque motor for controlling a fuel flow to the engine.

19. The system of claim 11, wherein obtaining the blade angle of the propeller comprises obtaining the blade angle from a propeller controller.

20. The system of claim 11, wherein the aircraft propeller is a first aircraft propeller and the blade angle is a first blade angle, the program instructions are further executable by the processing unit for obtaining a second blade angle of a second aircraft propeller, and wherein enabling reverse thrust comprises enabling reverse thrust when the first blade angle and second blade angle are below the threshold and inhibiting reverse thrust comprises inhibiting reverse thrust when at least one of the first blade angle and the second blade angle exceeds the threshold.
